(19) United States
(12) Patent Application Publication
(10) Pub. No.: US 2007/0102113 A1
(43) Pub. Date: May 10, 2007

(54) Methods of manufacturing engineered wood products

(75) Inventors: Kenneth K. Lau, Vancouver (CA); Michael J. Leach, Grande Prairie (CA); Donald G. Trudeau, Coquitlam (CA)

Correspondence Address: KOLISCH HARTWELL, P.C., 200 PACIFIC BUILDING, 520 SW YAMHILL STREET, PORTLAND, OR, 97204, US

(73) Assignee: Ainsworth Lumber Co., Ltd.

(21) Appl. No.: 11/444,891

(22) Filed: May 31, 2006

Related U.S. Application Data
(63) Continuation-in-part of application No. 11/394,471, filed on Mar. 31, 2006.
(60) Provisional application No. 60/733,595, filed on Nov. 4, 2005.

(51) Int. Cl. B32B 37/00

(52) U.S. Cl. 156/307.7

(57) ABSTRACT

Methods for manufacturing an engineered wood product are disclosed. The method includes orienting two or more sets of wood pieces to provide a blanket of oriented pieces, the blanket of oriented pieces including two or more layers, wherein at least one of the sets of wood pieces includes a first resin and at least the other of the sets of wood pieces includes a second resin, and wherein the second resin is more washout resistant than the first resin; preheating at least a portion of the blanket of oriented pieces; and curing the first and second resins by exposing at least a part of the blanket of oriented pieces to at least one of an elevated temperature, an elevated pressure, and radiant energy. At least one of the blanket of oriented pieces and the preheating is configured to at least substantially minimize washout of the first resin.

### CROSS-REFERENCE TO RELATED APPLICATIONS

This application is a continuation-in-part of U.S. Patent Application Ser. No. 11/394,471, filed Mar. 31, 2006 and entitled “Methods of Manufacturing Engineered Wood Products,” which claims priority under 35 U.S.C. § 119(e) to U.S. Provisional Patent Application Ser. No. 60/733,595 entitled “OSB/OSL Process Using Optimized PF Face Layers and MDI Core with Steam Preheating,” filed Nov. 4, 2005. The complete disclosures of both applications are hereby incorporated by reference for all purposes.

### BACKGROUND OF THE DISCLOSURE

Engineered wood products have become more popular because those products typically make better use of available forest resources. For example, products may be produced from smaller and lower quality trees, as compared to conventional wood products. Engineered wood products have been used in several applications, such as panels, boards, timber, beams, headers, columns, studs, wood I-joists, and various other applications.

Engineered wood products typically are manufactured by bonding together wood strands, veneers, lumber, particles, and/or other forms of wood pieces to produce a larger composite material. Wood pieces may be blended with one or more resins, arranged in particular configuration(s), and then exposed to elevated temperatures, elevated pressures, and/or radiant energy to cure the resins. To facilitate the curing of the resins, the wood pieces may be preheated before being exposed to the elevated temperatures, elevated pressures, and/or radiant energy. For example, the arranged wood pieces may be preheated with steam, radio frequency, and/or microwave.

The use of steam for preheating may, however, cause washout of the resin and/or otherwise prevent the resins from curing. Washout resistant resins may be used to minimize washout. MDI (methylene diphenyl diisocyanate) resins are commonly used for producing strand-based composites and/or products, such as Oriented Strand Board (OSB), Oriented Strand Lumber (OSL), and Laminated Strand Lumber (LSL), using steam pressing or steam pre-heating because MDI resins react with water and are resistant to moisture. Release agent(s) typically must be used with the washout resistant resins because those resins may cause the wood pieces to adhere to the equipment used. Alternatively, the manufacturing process may be optimized in one or more other ways to minimize washout of the resin(s).

Examples of manufacturing processes are provided in U.S. Pat. Nos. 6,818,317; 6,800,352; 6,767,490; 6,136,408; 6,098,679; 5,718,786; 5,525,394; 5,470,631; 5,443,894; 5,425,976; 5,379,027; 4,364,984; 4,893,415; 4,751,131; 4,517,147; 4,364,984; 4,361,612; 4,198,763; 4,194,296; 4,068,991; 4,061,819; 4,058,906; 4,017,980; 3,811,200; 3,685,959; 3,308,013; 3,173,460; 3,164,511; 3,098,781; 2,343,740; and 1,023,606, and European Patent No. 0172930. The complete disclosures of those patents are hereby incorporated by reference for all purposes.

### SUMMARY OF THE DISCLOSURE

Some embodiments provide a method for manufacturing an engineered wood product. The method includes orienting two or more sets of wood pieces to provide a blanket of oriented pieces, the blanket of oriented pieces including two or more layers, wherein at least one of the sets of wood pieces includes a first resin and at least the other of the sets of wood pieces includes a second resin, and wherein the second resin is more washout resistant than the first resin; preheating at least a portion of the blanket of oriented pieces; and curing the first and second resins by exposing at least a part of the blanket of oriented pieces to at least one of an elevated temperature, an elevated pressure, and radiant energy. At least one of the blanket of oriented pieces and the preheating is configured to at least substantially minimize washout of the first resin.

### BRIEF DESCRIPTION OF THE DRAWINGS

FIG. 1 is a flow diagram of an example of a method of manufacturing engineered wood products.

FIG. 2 is a more detailed flow diagram of the method of FIG. 1.

FIGS. 3-4 are flow diagrams of other examples of a method of manufacturing engineered wood products.

### DETAILED DESCRIPTION OF THE DISCLOSURE

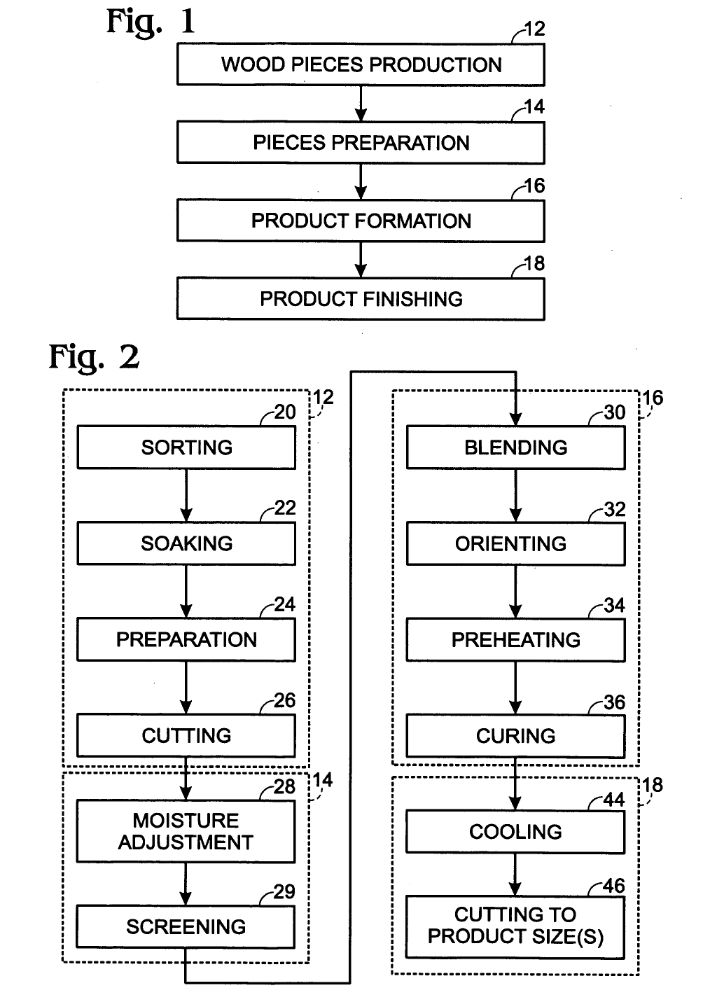

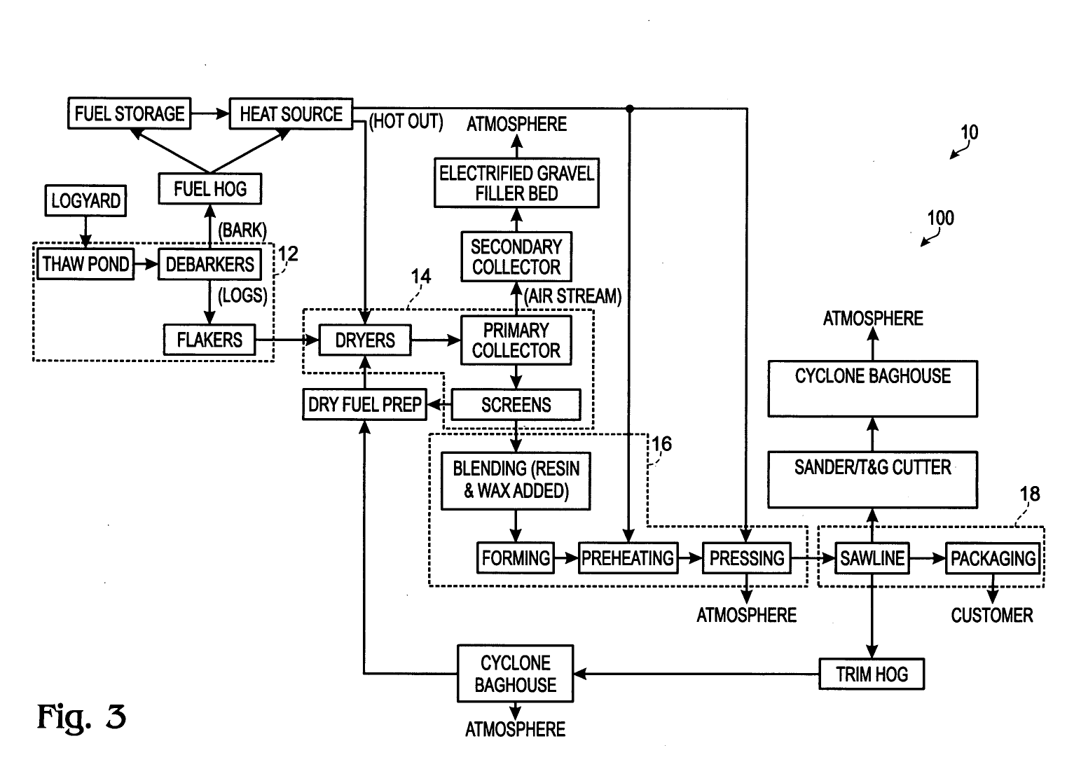

FIGS. 1-2 provide an example of a method for manufacturing engineered wood products, which is generally indicated at 10. The method may include any suitable steps configured to manufacture one or more types of engineered wood products. For example, method 10 may include the steps of wood pieces production at 12, pieces preparation at 14, product formation at 16, and product finishing at 18. The steps may be performed in different sequences and in different combinations, not all steps being required for all embodiments of method 10.

Wood pieces production at 12 may include one or more steps configured to produce the desired type of wood pieces from wood raw material(s), such as from any suitable type(s) of species of logs. For example, wood pieces production may include the steps of sorting at 20, soaking at 22, preparation at 24, and cutting at 26. The step of sorting may be configured to sort usable raw material(s) from unusable raw material(s). For example, log sorters may be used to sort out usable logs from unusable logs.

The step of soaking may be configured to soak raw material(s) to deice, heat, and/or prepare the wood, such as when the logs are below about 50° F. For example, logs may be heated in soaking or thaw ponds and/or via any suitable structure or equipment. The soaking or thaw pond(s) may be at any suitable temperature(s). For example, the logs may be heated in a pond of water having a temperature of up to about 176° F., up to about 140° F., or up to about 104° F. Specifically, the logs may be heated in the thaw pond having a temperature of about 86° F. to about 110° F. Additionally, the logs may be heated for more than about one hour. Specifically, the logs may be heated for about one hour to about forty-eight hours.

The step of preparation may be configured to prepare raw material(s) for the step of cutting, such as removing unusable parts of the raw material(s). For example, logs may be debarked in any suitable debarker(s), such as ring and drum debarkers. The step of cutting may be configured to cut or slice the prepared raw material(s) into the desired wood pieces. Flakers (such as disk flakers and ring flakers), stranders, and/or any other suitable equipment may be used to perform the step of cutting. As used herein, “wood pieces” may include flakes, strands, veneers, pieces, fines, and/or any suitable pieces sliced or otherwise cut from wood raw material(s), such as logs.

The wood pieces may be any suitable size(s). For example, when the desired wood pieces are flakes for strand-based products, then those flakes may have lengths (y-dimension) of up to about 12 inches or about 4.5 inches to about 6.0 inches, and may have widths (x-dimension) of up to about 12 inches or about 1.5 inches to about 2.5 inches. Similarly, those flakes may have a thickness (z-dimension) of about 0.001 inches to about 0.060 inches, or about 0.020 inches to about 0.030 inches. The width of the flakes may be a function of the length of the flakes. For example, the length of the flakes may be at least about three times greater than the width of the flakes, which may provide for proper flake orientation and acceptable physical properties for the engineered wood product.

Additionally, if the desired pieces are strands for OSL or LSL billets, then those strands may have lengths (y-dimension) of about 6 inches or about 0.5 inches to about 7 inches, and may have widths (x-dimension) of about 1 inch or about 0.04 inches to about 2.5 inches. Similarly, those strands may have a thickness (z-dimension) of about 0.031 inches, or about 0.01 inches to about 0.08 inches. The width of the strands may be a function of the length of the strands. For example, the length of the strands may be at least about three times to at least about six times greater than the width of the flakes. ASTM D5456-05 (sections 3.2.2.1 and 3.2.2.3), the complete disclosure of which is herein incorporated by reference for all purposes, defines LSL and OSL as a composite of wood strand elements with wood fibers primarily oriented along the length of the member with a least dimension (such as the lesser of a thickness or a width) of the strands of LSL and OSL not to exceed 0.10 inches. The average length of LSL shall be a minimum of 150 times the least dimension, and the average length of OSL shall be a minimum of 75 times the least dimension.

Although the wood pieces are described to have certain dimension ranges, those wood pieces may have any suitable dimensions. Additionally, although the step of wood pieces production is described to have certain steps, the step of wood pieces production may include any suitable steps configured to produce the desired type of wood pieces from raw material(s), such as from any suitable type(s) of species of logs. Moreover, the steps discussed above may be performed in different sequences and in different combinations, not all steps being required for all embodiments of method 10.

The step of pieces preparation at 14 may include one or more steps configured to prepare the wood pieces for producing the engineered wood product(s). For example, the step of pieces preparation may include the step of moisture adjustment at 28 and screening at 29. Any suitable dryer(s) may be used for the step of moisture adjustment, such as a tumble dryer, triple-pass dryer, a single-pass dryer, a combination triple-pass/single-pass dryer, and/or a three-section conveyor. Another example of a suitable dryer is one in which the wood pieces are laid on a chain mat and the wood pieces are held in place as they move through the dryer. The wood pieces may be dried under any suitable conditions (e.g., at a temperature of about 104° F. for about ten seconds or more), provided at least some of the water present is removed. Specifically, the wood pieces may be dried at about 150° F. to about 225° F. for about eight to ten minutes.

Although the step of moisture adjustment is described to include the use of one or more dryers, any suitable equipment may be used to adjust the moisture of the wood pieces. For example, the step may additionally, or alternatively, include the use of one or more moisture addition equipment.

Any suitable type of equipment may be used for the step of screening at 29. For example, rotating disk screens (triangular, square, and/or rectangular shaped disks) rotary screens and inclined vibrating conveyors with screened sections may be used. Although the step of pieces preparation is shown to include the step of moisture adjustment and the step of screening, the step of pieces preparation may include any suitable step(s) configured to prepare the wood pieces for producing the engineered wood product. The steps of pieces preparation may be performed in different sequences and in different combinations, not all steps being required for all embodiments of method 10.

The step of product formation at 16 may include one or more steps configured to produce an engineered wood product from the prepared wood pieces. For example, the step of product formation may include the steps of blending at 30, orienting at 32, preheating at 34, and curing at 36. The step of blending may be configured to contact at least part of one or more sets of the prepared wood pieces with one or more resins. For example, the step of blending at 30 may include the step of separating the wood pieces into two sets, the step of contacting at least part of a first set of wood pieces with a first resin, and the step of contacting at least part of a second set of wood pieces with a second resin. The first and/or second sets of wood pieces may include any suitable wood pieces. For example, the first and/or second set of wood pieces may include wood strands and/or wood flakes. Any suitable equipment may be used to perform the step of blending, such as separate rotating blenders for the first and second sets of wood pieces and spinning disk resin applicators and/or other resin applicators.

As used herein, “resin” may include an adhesive polymer of natural and/or synthetic origin. Any suitable resin(s) may be used in the blending step. For example, the resins may be thermoplastic polymers or thermosetting polymers. As used herein, “thermoplastic polymers” may include long-chain polymers that soften and flow on heating, and then harden again by cooling. Those polymers may generally have less resistance to heat, moisture, and long-term static loading than thermosetting polymers. Examples of resins that are based on thermoplastic polymers may include polyvinyl acetate emulsions, elastomerics, contacts, and hot-melts. As used herein, “thermosetting polymers” may undergo irreversible chemical change, and on reheating, may not soften and flow again. Those polymers may form cross-linked polymers that may have strength, may have resistance to moisture and other chemicals, and may be rigid enough to support high, long-term static loads without deforming. Examples of resins that are based on thermosetting polymers may include phenolic, resorcinolic, melamine, isocyanate, urea, and epoxy.

The resins may be of natural origin, synthetic origin, or may include a combination thereof. Resins of natural origin may include animal protein, blood protein, casein protein, soybean protein, lignocellulostic residue and extracts, bark-based resins, and combinations thereof. Resins of synthetic origin may include cross-linkable polyvinyl acetate emulsion, elastomeric contact, elastomeric mastic, emulsion polymer/isocyanate, epoxy, hot melt, isocyanate, formaldehyde, melamine and melamine urea, phenolic, polyvinyl acetate emulsion, polyurethane, resorcinol and phenol resorcinol, urea, and combinations thereof.

Specifically, the resins may include an isocyanate resin, a melamine resin, a phenol-formaldehyde (PF) resin, a melamine-formaldehyde (MF) resin, a phenol-melamine-formaldehyde (PMF) resin, a melamine-urea-formaldehyde (MUF) resin, a phenol-melamine-urea-formaldehyde (PMUF) resin, or a combination thereof. Examples of suitable isocyanate resins may include PMDI (polymethylene diphenyl diisocyanate); MDI (methylene diphenyl diisocyanate), or a combination thereof.

The phenols of the above resins may be substituted. Examples of suitable substituted phenols may include alkyl substituted phenols, aryl substituted phenols, cycloalkyl substituted phenols, alkenyl substituted phenols, alkoxy substituted phenols, aryloxy substituted phenols, and halogen substituted phenols, as disclosed in U.S. Pat. No. 5,700,587, the complete disclosure of which is hereby incorporated by reference for all purposes. Additional examples of suitable substituted phenols are disclosed in U.S. Pat. No. 6,132,549, the complete disclosure of which is hereby incorporated by reference for all purposes.

Additionally, or alternatively, the formaldehyde of the above resins may be replaced with another suitable aldehyde. Examples of suitable aldehydes include acetaldehyde, propionaldehyde, furfuraldehyde, and benzaldehyde. In general, the aldehyde employed may have the formula R′CHO wherein R′ is a hydrogen or a hydrocarbon radical of 1 to about 12 carbon atoms. Other examples of suitable aldehydes are disclosed in U.S. Pat. No. 5,700,587, the complete disclosure of which has been incorporated by reference for all purposes.

The resin may be a solid, such as a powder, a liquid, or a combination thereof. For example, the resin may be in at least substantially liquid form or the resin may be in at least substantially solid form. If the resin is a liquid, the liquid resin may be relatively viscous, relatively nonviscous, or somewhere in between. If the resin is a liquid and is a relatively viscous, then the resin may be diluted with one or more carriers to render the resin relatively nonviscous. Examples of suitable carriers may include water, organic hydrocarbons, or a combination thereof.

Some of the resins described above may be more washout resistant than other resins. Thus, a blanket of oriented pieces formed from the wood pieces may be configured to at least substantially minimize washout of the resin by, at least in part, using resins that are more washout resistant than other resins. As used herein, “washout” may refer to loss of at least a portion of the resin during one or more steps of method 10 before the resin is cured, such as the preheating step at 34. As used herein, “washout resistant” or “washout resistance” may refer to characteristic(s) of the resin to remain at least in partial contact with the wood pieces and/or to resist washout before the resin is cured.

When steam is used during at least part of the preheating step, an isocyanate resin (such as MDI) may be more washout resistant than a PF resin. When MDI is used, one or more release agents may be used to minimize adherence of the wood pieces having MDI to one or more portions of the equipment used in method 10, such as the steel used in the presses of the step of curing. The release agent(s) may be mixed with the MDI and/or applied to surface(s) of the equipment.

Some of the resins described above may react with water and may thus be more washout resistant than other resins that do not react with water. For example, when steam is used during at least part of the preheating step, isocyanate resins may react with water, while PF resins may not react with water. Although isocyanate resins are discussed to be more washout resistant than PF resins, other resins also may be more washout resistant than PF resins and/or less washout resistant than isocyanate resins. Additionally, although isocyanate resins are discussed to react with water and PF resins are discussed to not react with water, other resins also may react with water and other resins may not react with water.

Additional examples of suitable resins may be found in the Handbook of Thermoset Plastics; Wood Handbook, sections 9-16, 9-9, 10-3, and 10-4; Forest Products Society Publications (http://www.forestprod.org); Wood Adhesives 2000, extended abstracts cat. No. 7260; International Contributions to Wood Adhesion Research, cat No. 7267; Wood Adhesives 1999, cat No. 7266; 1998 Resin Binding Seminar Proceedings, cat No. 7266; Handbook of Pressure Sensitive Adhesive Technology, 3^{rd} edition by Donatas Satas, Hardcover; Handbook of Adhesive Technology, by A. Pizzi, K. L. Mittal, Hardcover; Resin Transfer Moulding, by Kevin Potter, Hardcover; and Cyanoacrylate Resins: The Instant Adhesives, by Henry L. Lee, Paperback, T/C Press, January 1986; and references cited therein. The complete disclosures of the above references are hereby incorporated by reference for all purposes.

Additional examples of suitable resins may be found in U.S. Pat. Nos. 6,136,408; 6,132,885; 6,132,549; 6,028,133; 5,974,760; 5,951,795; 5,861,119; 5,714,099; 5,700,587; 5,635,118; 5,554,429; 5,552,095; 5,425,908; 4,758,478; 4,514,532; 4,407,999; 4,364,984; and references cited therein. The complete disclosures of the above patents are hereby incorporated by reference for all purposes.

In the example discussed above, at least part of the first set of wood pieces may be contacted with at least one PF resin, while at least part of the second set of wood pieces may be contacted with at least one isocyanate resin (or at least one MDI resin). The at least one PF resin may be in at least substantially liquid form or at least substantially solid form. Alternatively, the at least one PF resin may include one or more PF resins in at least substantially liquid form and one or more PF resins in at least substantially solid form.

Additionally, the first and/or second sets of wood pieces may be contacted with wax and/or other additives during the step of blending. For example, wax may be added to improve the efficiency of the resin(s) used and/or enhance the resistance of the blanket of oriented pieces to moisture and water absorption. Other additive(s) may additionally, or alternatively, be used to provide the engineered wood product with particular characteristics. For example, pesticides and/or fungicides may be used to provide engineered wood products that are resistant to pests, such as termites, and/or fungus, as described in U.S. Pat. No. 6,818,317. The complete disclosure of that patent has been incorporated by reference for all purposes.

Although the first set of wood pieces is described to be contacted with at least one PF resin and the second set of wood pieces is described to be contacted with at least one isocyanate resin, the first and/or second sets of wood pieces may alternatively, or additionally, be contacted with one or more other suitable resins. Additionally, although the first and second sets of wood pieces are discussed to be contacted with different resins, both sets of wood pieces may be contacted with the same resin. Moreover, although the prepared wood pieces are discussed to be separated into two sets of wood pieces, the prepared wood pieces may be separated into three or more sets of wood pieces, with those sets of wood pieces being contacted with one or more resins.

The step of orienting the wood pieces at 32 may be configured to provide or form a mat or blanket of oriented pieces. The blanket of oriented pieces may have any suitable numbers and/or types of layers. For example, the blanket of oriented pieces may include a core layer sandwiched between a pair of face layers. Any suitable set or combination of sets of wood pieces from the blending step may be used to form one or more of the layers of the blanket of oriented pieces. For example, the core layer may be formed of the second set of wood pieces, while the pair of face layers may be formed of the first set of wood pieces.

Additionally, the wood pieces may be oriented in any suitable direction in each of the layers. For example, at least a substantial portion of the wood pieces of the core layer and the face layers may be oriented at least substantially lengthwise (or along the length of the engineered wood product). Alternatively, at least a substantial portion of the wood pieces of the core layer may be oriented at least substantially perpendicular to at least a substantial portion of the wood pieces of the face layers.

Moreover, the layers of the blanket of oriented pieces may have any suitable weight ratios to at least substantially minimize washout of the one or more resins, such as any suitable face-layers-to-core-layer weight ratio before the step of preheating. For example, the face-layers-to-core-layer weight ratio before the step of preheating may be based, at least in part, on a target thickness for the engineered wood product, a target density for the engineered wood product, preheating time, washout resistance of the resin used for the core layer, washout resistance of the resin used for the face layer(s), and/or other suitable factors. In some engineered wood products (such as oriented strand lumber and laminated strand lumber), the face-layers-to-core-layer weight ratio before steam preheating may range from about 5% to 95%, to about 40% to 60% to at least substantially minimize washout of the one or more resins. In some engineered wood products (such as oriented strand lumber and laminated strand lumber), the face-layers-to-core-layer weight ratio before steam preheating may range from about 11.4% to 88.6%, to about 21.2% to 78.8% to at least substantially minimize washout of the one or more resins.

Similarly, the layers of the blanket of oriented pieces may have any suitable weight per unit area to at least substantially minimize washout of the one or more resins, such as any suitable weight per unit area before the step of preheating. For example, one or both of the face layers may have a weight per unit area before the step of preheating based, at least in part, on a target thickness for the engineered wood product, a target density for the engineered wood product, preheating time, washout resistance of the resin used for the core layer, washout resistance of the resin used for the face layer(s), and/or other suitable factors. In some engineered wood products (such as oriented strand lumber and laminated strand lumber), the weight per unit area of one or each of the face layers may be about 0.2 to about 1.2 pounds per square foot (lbs/ft²) before the step of steam preheating to at least substantially minimize washout of the one or more resins. In some engineered wood products (such as oriented strand lumber and laminated strand lumber), the weight per unit area of one or each of the face layers may be about 0.27 to about 0.7 lbs/ft² before the step of steam preheating to at least substantially minimize washout of the one or more resins.

Any suitable equipment may be used for the step of orienting or forming the wood pieces. For example, orienting equipment may include disk-type and star-type orienters, and may range from electrostatic equipment to mechanical devices containing spinning disks, orienting disks, and/or other types of equipment to align wood pieces. Some equipment may use the dimensional characteristics of the wood pieces to achieve the desired alignment onto a moving caul plate or conveyor belt below forming heads. Oriented layers of wood pieces within the blanket may be dropped sequentially, each with a different forming head. Some equipment may use wire screens to carry the blanket into the press or screenless systems in which the blanket may lie directly on the conveyor belt.

Although the blanket of oriented pieces is described to include a core layer sandwiched between a pair of face layers, the blanket of oriented pieces may include any suitable number of layers. Additionally, although the blanket of oriented pieces is discussed to have certain face-layers-to-core-layer weight ratios or have layers with certain weight per unit area, the blanket of oriented pieces may have any suitable face-layers-to-core-layer weight ratio or have layers with any suitable weight per unit area configured to at least substantially minimize washout of the first resin. For example, the use of resin(s) in solid form and/or resin(s) that are more washout resistant may allow the blanket of oriented pieces to have one or both face layers with higher weights per unit area then described above. Moreover, although the layers of the blanket of oriented pieces is described to have at least a substantial portion of wood pieces oriented in specific orientations, those layers may include any suitable portion(s) of wood pieces oriented in any suitable orientation(s).

The step of preheating at 34 may be configured to preheat at least a portion of the blanket of oriented pieces. Preheating may facilitate or shorten time required for the step of curing, particularly for thicker engineered wood products, such as oriented strand lumber (OSL) and laminated strand lumber (LSL). Any suitable portion(s) of the blanket of oriented pieces may be preheated. For example, at least a substantial portion of the core layer may be preheated. Alternatively, at least a substantial portion of one or both of the face layers may be preheated. Alternatively, at least a substantial portion of the blanket of oriented pieces may be preheated.

Any suitable material(s) and/or equipment may be used to preheat. For example, steam at any suitable concentration may be injected and/or otherwise introduced to the blanket of oriented pieces. Preheating with steam (or steam preheating) may be performed for any suitable period of time to at least substantially minimize washout of the one or more resins. For example, the steam preheating may be performed for a sufficient period of time to raise the temperature of at least a substantial portion of the core layer to a target core temperature.

The target core temperature may be based, at least in part, on a target thickness for the engineered wood product, a target density for the engineered wood product, washout resistance of the resin used for the core layer (such as the first resin in the example described above), washout resistance of the resin used for the face layer (such as the second resin in the example described above), and/or other suitable factors. For example, a target core temperature may be about 212° F. to about 221° F.

In some blankets of oriented pieces, a sufficient period of time for the steam preheating may be about 20 seconds to about 70 seconds for the core layer to reach a target core temperature of about 212° F. to about 221° F. to at least substantially minimize washout of the one or more resins. In some blankets of oriented pieces, a sufficient period of time for the steam preheating may be about 30 seconds to about 32 seconds for the core layer to reach a target core temperature of about 212° F. to about 221° F. to at least substantially minimize washout of the one or more resins.

Any suitable equipment may be used to preheat the blanket of oriented pieces. For example, the preheating may at least substantially be performed in a continuous press where the step of curing also is performed. Alternatively, or additionally, the preheating may be performed in a separate preheater, and/or other suitable equipment.

Although the step of preheating is discussed to include steam injection or steam preheating, the step of preheating may include any suitable step(s) and/or any suitable equipment configured to preheat at least a portion of the blanket of oriented pieces. For example, hot air, radio frequency and/or microwave equipment may alternatively, or additionally, be used for the step of preheating. Additionally, although the step of preheating is discussed to include steam, the step of preheating may include any suitable material(s). For example, air and/or electromagnetic radiation may additionally, or alternatively, be used for the step of preheating.

Moreover, although the step of preheating is discussed to have particular target core temperatures and steam preheating times are discussed, the step of preheating may include any suitable target core temperature(s) and steam preheating time(s) to at least substantially minimize washout of the one or more resins. For example, varying one or more parameters of the method, such as the speed of the continuous press, may allow steam preheating times of less than 20 seconds or more than 70 seconds. Furthermore, although the step of preheating is described to be performed in a continuous press, the step of preheating may be performed via any suitable equipment, including any suitable type(s) of batch equipment.

The step of curing at 36 may include any suitable step(s) configured to cure the one or more resins, such as exposing at least a part of the blanket of oriented pieces to an elevated temperature, an elevated pressure, and/or radiant energy to cure the first and second resins. For example, hot pressing may be used to compress the blanket of oriented pieces under elevated temperature and elevated pressure to cure the one or more resins. Any suitable equipment may be used, such as multiple-opening or continuous presses, such as steam injection presses. For example, the step of curing may at least substantially be performed in a continuous press.

As used herein, “elevated temperature” may include any temperature above room temperature of 77° F. The elevated temperature may be above about 212° F., above about 302° F., above about 392° F., or up to about 482° F. Specifically, the elevated temperature may be about 77° F. to about 599° F., about 77° F. to 425° F., about 212° F. to about 425° F., or about 374° F. to about 425° F. More specifically, when the desired engineered wood product is an oriented strand board (OSB), the elevated temperature may be about 325° F. to about 475° F., may be about 350° F. to about 450° F., or about 375° F. to about 425° F. More specifically, when the desired engineered wood product is plywood, elevated temperature may be about 225° F. to about 425° F., about 250° F. to about 400° F., or about 275° F. to about 375° F. More specifically, when the desired engineered wood product is oriented strand lumber (OSL) or laminated strand lumber (LSL), elevated temperature may be about 257° F., or about 248° F. to 266° F.

As used herein, “elevated pressure” may include any pressure above standard pressure of 1 atmosphere (atm). Elevated pressure may be above about 5.0 atm, above about 10.0 atm, above about 20.0 atm, above about 40.0 atm, or above about 80.0 atm. Specifically, the elevated pressure may be about 60.0 atm to about 85.0 atm. More specifically, when the desired engineered wood product is OSB, then the elevated pressure may be about 25 atm to about 55 atm, about 30 atm to about 50 atm, about 34 atm to about 48 atm, or about 35 atm to about 45 atm. More specifically, when the desired engineered wood product is plywood, then the elevated pressure may be about 8.0 atm to about 21 atm or about 10.0 atm to about 17 atm. More specifically, when the desired engineered wood product is OSL or LSL, elevated pressure may be about 21.1 atm to about 40.8 atm, or about 8.2 atm to about 9.5 atm.

Although the step of curing is discussed to include the step exposing at least part of the blanket of oriented pieces to an elevated temperature, elevated pressure, and/or radiant energy, the step of curing may include any suitable step(s) configured to cure the one or more resins. Additionally, although specific elevated temperature and pressure ranges are provided, any suitable elevated temperatures and pressures may be used. Moreover, although specific elevated temperatures and pressure ranges are provided for OSB, plywood, OSL, and LSL, suitable elevated temperature and pressure ranges, which may be the same or different from the ranges discussed for OSB, plywood, OSL, and LSL, may be used for other desired engineered wood products.

Although the step of product formation at 16 is shown to include the steps of blending, forming, preheating, and curing, the step of product formation may include any suitable step(s) configured to form the desired engineered wood product from the prepared wood pieces. Additionally, the steps discussed above may be performed in different sequences and in different combinations, not all steps being required for all embodiments of method 10.

Product finishing at 18 may include one or more steps configured to finish the engineered wood product. For example, the product finishing may include the steps of cooling at 44, cutting to desired size(s) at 46, grade stamping at 48, stacking at 50. Although the step of product finishing at 18 is discussed to include particular step(s), the step of product finishing may include any suitable step(s) configured to finish the desired engineered wood product. For example, the step of product finishing may additionally, or alternatively, include grade stamping and/or edge coating. Additionally, the steps discussed above may be performed in different sequences and in different combinations, not all steps being required for all embodiments of method 10.

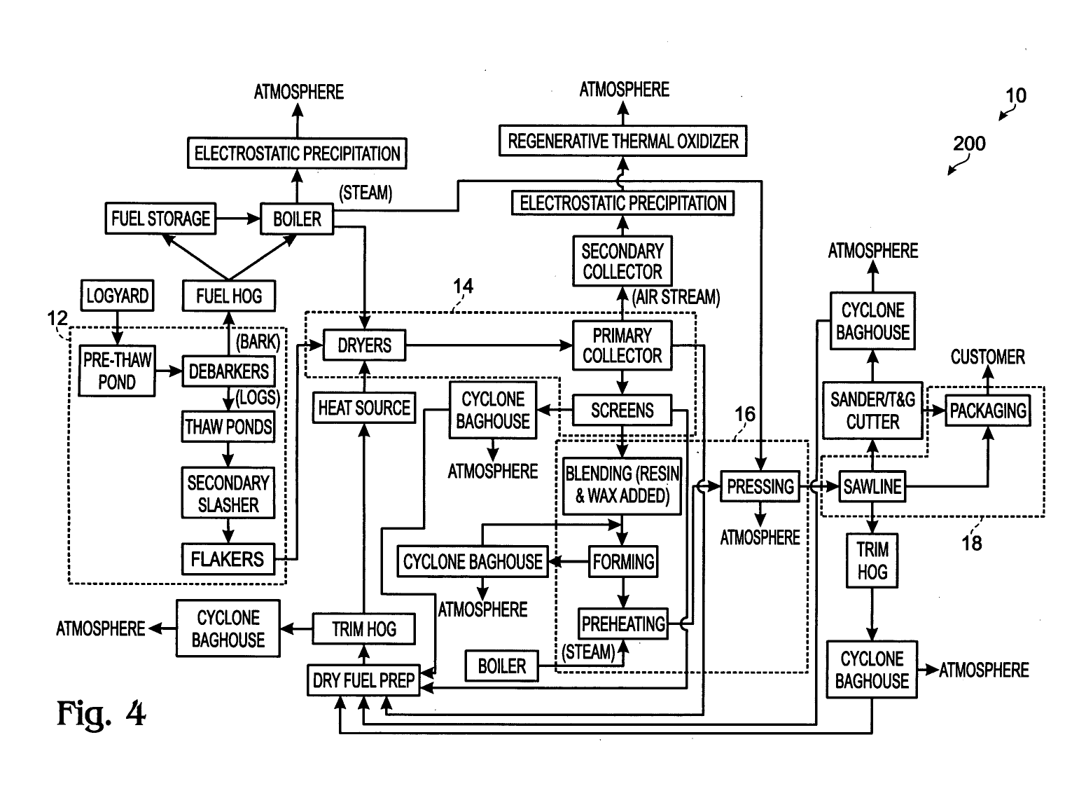

Although method 10 is shown to include specific steps, the method may include any suitable step(s) configured to manufacture engineered wood product(s). Additional examples of method 10 are shown in FIGS. 3-4 and are generally indicated at 100 and 200, respectively. Other examples also are provided below.

### EXAMPLE 1

### Pressing of 1″OSL/LSL Panel with Steam Pre-Heating

Strands were cut using custom-made knife holders. Each strander knife was set up to cut two 7″ strands and two 6″ strands. Strand analysis showed the following results for the mass weighted averages:

Thickness=0.77 mm (0.030″)

Length=153 mm (6.024″)

Width=64.2 mm (2.528″).

General observations indicated that the strands had a high percentage of wide width strands prior to blending/forming and the strands appeared to break up to narrower widths after blending and forming.

The panel was formed with a target oven-dry density of 43 lbs/cu ft. Hexion liquid PF (LPF) and powder PF (PPF) resin system was used for the face layers. 6% solid of Hexion LPF 101 K2 and 3.5% solid of W800C PPF resins were used for the face layers. The strand moisture content for the face layers was ˜1.8%. 6% MDI was used for the core layer. The core strands were blended to a moisture content of 7%. 1.2% of E-Wax was used for both the face and core layers.

The required strands were pre-blended with the two resin systems (i.e. LPF/PPF and MDI). The liquid PF resin was blended at 22 rpm and the powder PF was blended at 6 rpm. The face layer weight was 0.33 lbs of strands per square foot. The target density of this panel was 43 lbs/cu ft. The face to core ratio for the 1″ thick panel was 18% to 82%.

The platen temperature of 130° C. (266° F.) was used and the press time was seven minutes. A slow open degassing cycle was used. The press was opened up after the highest gas pressure came down to 6 psi. The board appeared to be solid with no signs of delamination. This strategy may allow production of OSL or LSL billets without the need to use MDI release agent.

### EXAMPLE 2

### Pressing of 1″ Thick OSL/LSL Panel with Steam Pre-Heating

The same 6″ & 7″ strand length combination as the examples above were used. The average alignment with the orientation rolls centered was 17.5 degrees (20.2, 15.9, and 16.3). Resins used were Hexion LPF for the face layers and MDI for the core layer. The panel was produced with a 10% (0.4 lbs/ft) face layer. This panel was produced with no delaminations. All parameters were the same as the previous example, with the exception of a slight face layer thickness correction. The maximum pressure for this pressing was ˜500 psi with a peak internal gas pressure of 35 psi. Minimum internal gas pressure of 9 psi was achieved after 60 seconds of degas. This panel, based on testing of the trim edges, had an internal bond of 104 psi (break locations 2, 2, 1, 1, 2, 2) with a modulus of elasticity (MOE) value of 1.281 million psi. The MOE values were affected by an outlier due to a lower density replicate from the panel edge. The MOE value with the outlier removed was 1.335 million psi (1.320 and 1.349) with an average density of 48.6 lb/ft³ (49.4 and 47.8). The average strand alignment was ˜18.6°.

### EXAMPLE 3

### Pressing of 1″ Thick OSL/LSL Panel with Steam Pre-Heating

Dynea LPF face/MDI core panels with a 10% (0.40 lbs/ft²) face layer were produced. The face layer for this panel was reduced to 7%. Furnish moisture content, resin and wax rates were the same as for the Example 2 panel.

This panel was produced with no delaminations. Maximum pressure for this pressing was ˜500 psi with a peak internal gas pressure of 9 psi. Minimum internal gas pressure of 3-4 psi was achieved prior to degas but the same degas method was used to remain consistent. The average internal bond for this panel was 112.9 psi (break locations 1, 1, 5, 4, 5, 4). The average hot MOE value was 1.576 million psi with replicate densities slightly below target (47.7, 45.6 and 47.3). Average panel density was 48.7 lbs/ftˆ3. The average strand alignment was ˜16.8°. The improved strand alignment was attained by paying closer attention to minimize the daylight or distance between the orienters and the mat. The improved strand alignment led to a significant improvement in the edge bending MOE.

### EXAMPLE 4

### Pressing of 1¾″ Thick OSL/LSL Panel with Steam Pre-Heating

A 1¾″ thick OSL/LSL panel using the Hexion LPF for Face with a 10% by weight or 0.7 lb/sq ft per face layer and MDI for core was prepared. 7″ length Aspen strands were cut using a lab strander. Mass weighted strand lengths of the strands were about 6″ to 6.25″. The average strand alignment was 13.9°. The pressing strategy followed the same method as the previous example. No delaminations were observed. A 30-second steam pre-heating was simulated in the daylight press by compressing the mat to 11.5 lbs/ft³ and injecting steam. A simple pressure curve was used to close quickly to 0.070″ below thickness and then back off to target thickness after 60 seconds. A manual venting cycle of ˜60 seconds was used as before to reduce internal gas pressure to a safe level before opening.

### EXAMPLE 5

### Pressing of 1¾″ Thick OSL/LSL Panel with Steam Pre-Heating

A 1¾″ thick panel with Hexion LPF for the face layer (at 5.7% or 0.4 lbs/ft² per face layer) and 6% MDI for the core layer was produced. The panel surface after pressing was smooth and the panel was sound with no signs of delamination.

### EXAMPLE 6

### Pressing of 1¾″ Thick OSL/LSL Panel with Steam Pre-Heating

The target density for the panel was 42 lbs/ft³. The Hexion LPF (HPC51) resin for the face layers was at 8%, and the Huntsman (R1840) MDI resin for the core layer was at 6% solids. The PF face layer was at 0.65 lbs/ft². The total press time was 9.5 minutes. The core moisture was 6%. The core temperature was ˜99.4° C. after 5 to 6 minutes under pressure. The panel was sound with no delamination.

The pre-steaming time was 30 seconds, which did not cause the PF resin to wash out for the 1¾″ thick OSL/LSL panels because the steam was required for the thicker panels and was driven into the thicker panel. For thinner panels (e.g., 1″ panels) the steaming time may need to be reduced or the PF face layer would need to be reduced to prevent PF resin wash-out.

### EXAMPLE 7

### Pressing of 1¾″ Thick OSL Panel with Steam Pre-Heating

A panel was formed with 0.5 lbs/ft² Hexion HPC 51 LPF face layers and an MDI core layer (16.7 to 83.3% faces to core ratio). A steaming time of 32 seconds was used. The target out-of-press density was 41 lbs/ft³. The panel appeared to be sound with no delamination. The density of hot bending specimens taken from the edge trims was 38.5 lbs/ft³. The mean hot MOE was 972,000 psi. The mean hot modulus of rupture (MOR) was 6,830 psi, while the mean hot internal bond was 46.5 psi (break locations 3, 4, 4, 4, 2, 3).

### EXAMPLE 8

### Pressing of 1¾″ Thick OSL/LSL Panel with Steam Pre-Heating

A panel was formed with 0.5 lbs/ft² Hexion HPC 51 LPF face layers and an MDI core layer (16.7 to 83.3% faces to core ratio). The panel was pressed with a steaming time of 30 seconds. A longer steaming time was not necessary for the OSL/LSL density of 41 lbs/ft³. The panel was good with no delamination. The density of hot bending specimens taken from the edge trims was 42.2 lbs/ft³. The mean hot MOE was 1,269,000 psi. The mean hot modulus of rupture (MOR) was 8,860 psi, while the mean hot internal bond was 66.3 psi (break locations 2, 2, 2, 2, 2).

### EXAMPLE 9

### Pressing of 1¾″ Thick OSL/LSL Panel with Steam Pre-Heating

A panel was formed with 0.6 lbs/ft² Hexion HPC 51 LPF face layers and an MDI core layer (20 to 80% faces to core ratio). The target out-of-press density was 41 lbs/ft³. The panel was sound with no delamination.

Although the methods of manufacturing engineered wood and features of those methods have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

What is claimed is:

1. A method of manufacturing an engineered wood product, comprising:
orienting two or more sets of wood pieces to provide a blanket of oriented pieces, the blanket of oriented pieces including two or more layers, wherein at least one of the sets of wood pieces includes a first resin and at least the other of the sets of wood pieces includes a second resin, and wherein the second resin is more washout resistant than the first resin;
preheating at least a portion of the blanket of oriented pieces; and
curing the first and second resins by exposing at least a part of the blanket of oriented pieces to at least one of an elevated temperature, an elevated pressure, and radiant energy,
wherein at least one of the blanket of oriented pieces and the preheating is configured to at least substantially minimize washout of the first resin.

2. The method of claim 1, wherein at least one of the sets of wood pieces includes wood strands.

3. The method of claim 2, wherein the wood strands include strands with a least dimension of at most 0.1 inches and a length of at least 150 times the least dimension.

4. The method of claim 3, wherein the least dimension is a thickness of the strands.

5. The method of claim 2, wherein the wood strands include strands with a least dimension of at most 0.1 inches and a length of at least 75 times the least dimension.

6. The method of claim 5, wherein the least dimension is a thickness of the strands.

7. The method of claim 1, wherein at least a substantial portion of the wood pieces of at least one of the layers are oriented at least substantially in a first direction and at least a substantial portion of the wood pieces of the at least one of the other layers are oriented at least substantially in a second direction.

8. The method of claim 7, wherein the first direction is at least substantially parallel to the second direction.

9. The method of claim 7, wherein the first direction is at least substantially perpendicular to the second direction.

10. The method of claim 1, wherein the first resin includes at least one phenol-formaldehyde (PF) resin.

11. The method of claim 10, wherein the at least one PF resin is in at least substantially liquid form.

12. The method of claim 10, wherein the at least one PF resin is in at least substantially solid form.

13. The method of claim 10, wherein the at least one PF resin includes one or more PF resins in at least substantially liquid form and one or more PF resins in at least substantially solid form.

14. The method of claim 1, wherein the second resin includes at least one methylene diphenyl diisocyanate (MDI) resin.

15. The method of claim 1, wherein at least one of the layers has a weight per unit area before the preheating based, at least in part, on at least one of a target thickness for the product, a target density for the product, preheating time, and washout resistance of the first resin.

16. The method of claim 15, wherein the weight per unit area of at least one of the layers is about 0.2 to about 1.2 pounds per square foot (lbs/ft2) before the preheating.

17. The method of claim 1, wherein the preheating is for a sufficient period of time to raise the temperature of at least a substantial portion of at least one the layers to a target temperature based, at least in part, on at least one of a target thickness for the product, a target density for the product, and washout resistance of the first resin.

18. The method of claim 17, wherein the sufficient period of time for the preheating is about 20 seconds to about 70 seconds.

19. The method of claim 1, wherein preheating at least a portion of the blanket of oriented pieces includes preheating with at least one of steam and air.

20. A method of manufacturing an engineered wood product, comprising:
orienting two or more sets of wood pieces to provide a blanket of oriented pieces, the blanket of oriented pieces including two or more layers, wherein at least one of the sets of wood pieces includes at least one PF resin and at least the other of the sets of wood pieces includes at least one MDI resin;
steam preheating at least a portion of the blanket of oriented pieces; and
curing the first and second resins by exposing at least a part of the blanket of oriented pieces to at least one of an elevated temperature, an elevated pressure, and radiant energy,
wherein at least one of the layers has a weight per unit area of about 0.2 to 1.2 pounds per square foot (lbs/ft2) before the steam preheating.

21. The method of claim 20, wherein at least a substantial portion of the wood pieces of the layers are oriented at least substantially lengthwise.

22. A method of manufacturing strand-based lumber, comprising:
orienting lengthwise two or more sets of wood strands to provide a blanket of oriented strands, the blanket of oriented strands including two or more layers, wherein at least one of the sets of wood strands includes at least one PF resin and at least the other of the sets of wood strands includes at least one MDI resin;
steam preheating at least a portion of the blanket of oriented strands for a sufficient period of time based, at least in part, on at least one of a target thickness for the product, a target density for the product, and washout resistance of the at least one PF resin; and
curing the at least one PF resin and the at least one MDI resin by exposing at least a part of the blanket of oriented strands to at least one of an elevated temperature, an elevated pressure, and radiant energy,
wherein at least one of the layers has a weight per unit area of about 0.2 to 1.2 pounds per square foot (lbs/ft2) before the steam preheating.

23. The method of claim 22, wherein the layers include a core layer sandwiched between a pair of face layers.

24. The method of claim 22, wherein the core layer includes the at least one PF resin and the face layers include the at least one MDI resin.
